(19) United States
(12) Patent Application Publication
(10) Pub. No.: US 2023/0196707 A1
(43) Pub. Date: Jun. 22, 2023

(54) FIDUCIAL PATTERNS

(71) Applicants: PURDUE RESEARCH FOUNDATION, West Layfayette, IN (US); HEWLETT-PACKARD DEVELOPMENT COMPANY, L.P., Spring, TX (US)

(72) Inventors: Ziyi ZHAO, West Layfayette, IN (US); Robert ULICHNEY, Stow, MA (US); Stephen Bernard POLLARD, Bristol (GB); Matthew D. GAUBATZ, Seattle, WA (US); Jan Philip ALLEBACH, West Layfayette, IN (US)

(21) Appl. No.: 17/926,948

(22) PCT Filed: May 22, 2020
(86) PCT No.: PCT/US2020/034416

§ 371 Date: Nov. 21, 2022

(51) Int. Cl. G06V 10/22

(52) U.S. Cl. CPC G06V 10/225; G06V 10/23

(57) ABSTRACT

Examples of methods for fiducial pattern detection are described herein. In some examples, a method may include detecting fiducial pattern subsets in image subsets of an image of an object. In some examples, the method may also include selecting a first image subset that includes a largest first fiducial pattern subset. In some examples, the method may further include extending the first fiducial pattern subset from the first image subset to a neighboring second image subset.

### BACKGROUND

Items may be labeled or marked. For example, items may be labeled or marked to convey information about the items. Some items may be labeled with text, characters, or symbols. For instance, labeling may be utilized to inform a person about an item, such as materials in clothing, washing directions for clothing, nutrition information for food products, prices of goods, warning labels for machinery, usage directions for pharmaceutical products, etc. In some cases, labeling may be utilized for tracking items (e.g., items for inventory tracking or purchase) or for automated procedures (e.g., detection, sorting, quality control, etc.).

### BRIEF DESCRIPTION OF THE DRAWINGS

FIG. 1 is a flow diagram illustrating an example of a method for fiducial pattern detection;

FIG. 2 is a flow diagram illustrating an example of a method for fiducial pattern detection;

FIG. 3 is a block diagram of an example of an apparatus that may be used in fiducial pattern detection;

FIG. 4 is a block diagram illustrating an example of a computer-readable medium for fiducial pattern detection;

FIG. 5 is a diagram illustrating an example of a line crossing in accordance with some examples of the techniques described herein;

FIG. 6 is a diagram illustrating an example of an image subset in accordance with some examples of the techniques described herein;

FIG. 7 is a diagram illustrating an example of an image subset order in accordance with some examples of the techniques described herein; and

FIG. 8 is a diagram illustrating an example of an image of a cylindrical object with a detected fiducial pattern in accordance with some examples of the techniques described herein.

### DETAILED DESCRIPTION

Some examples of the techniques described herein are related to fiducial patterns. A fiducial pattern is a pattern of marks. Examples of marks may include dots, lines, crosses, characters, and/or symbols, etc. In some examples, a fiducial pattern may be an arrangement of marks in a recurring pattern. For instance, a fiducial pattern may include marks that are arranged according to a grid (e.g., polygonal grid, rectangular grid, triangular grid, hexagonal grid, etc.), where the marks are positioned at grid intersections and/or vertices. In some examples, the marks and/or grid may be uniform or non-uniform. Marks that correspond to a fiducial pattern may be referred to as fiducial marks (e.g., fiducial dots). In some examples, the fiducial pattern may include a set of halftone dots.

In some examples, a fiducial pattern may appear on an object. For example, an object may exhibit a fiducial pattern and/or a fiducial pattern may be placed, printed, labeled, and/or marked, etc., on an object. In some examples, the object may be a curved and/or non-planar object. For instance, the fiducial pattern may appear on a curved surface of the object. In some examples, the object may be a three-dimensional (3D) object, where the fiducial pattern appears on a non-planar surface of the 3D object. A viewing perspective of the object and/or the curved and/or non-planar surface of an object may result in a distorted (e.g., bent, modified, non-planar, etc.) appearance of the fiducial pattern.

Some approaches to recovering a fiducial pattern may constrain the fiducial pattern to flat or planar surfaces. This constraint may limit marking for some objects (e.g., 3D printed objects), where a flat surface of the objects has a limited size, is inaccessible, or is nonexistent.

Some examples of the techniques described herein may allow detecting a fiducial pattern on non-planar and/or curved surfaces. In some examples, an image of the surface may be segmented into image subsets (e.g., tiles, windows, regions, etc.) that correspond to portions of an object that are approximately planar. In some examples, fiducial pattern detection may start by detecting a fiducial pattern subset in an image subset. In some examples, pattern detection may proceed by extending the fiducial pattern subset to overlapping image subsets. In some examples, pattern detection may continue until detection is performed in all image subsets that include a portion of the fiducial pattern (and/or until all image subsets that include a portion of the fiducial pattern are aligned).

Throughout the drawings, identical reference numbers may designate similar, but not necessarily identical, elements. Similar numbers may indicate similar elements. When an element is referred to without a reference number, this may refer to the element generally, without necessary limitation to any particular figure. The figures are not necessarily to scale, and the size of some parts may be exaggerated to more clearly illustrate the example shown. Moreover, the drawings provide examples and/or implementations in accordance with the description; however, the description is not limited to the examples and/or implementations provided in the drawings.

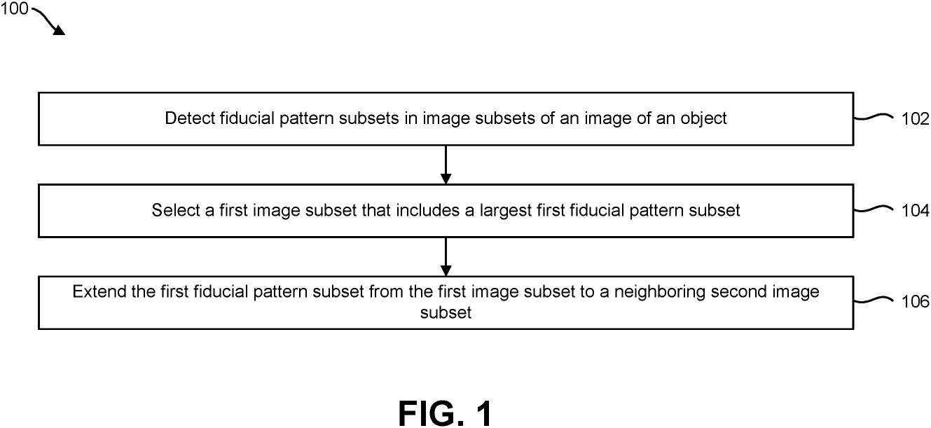

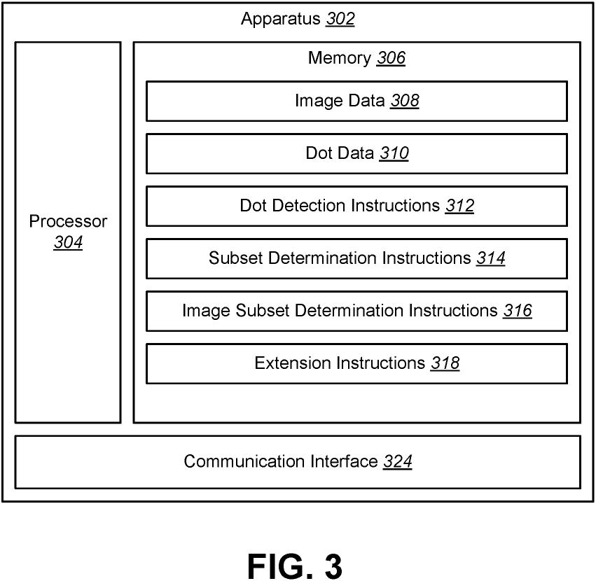

FIG. 1 is a flow diagram illustrating an example of a method 100 for fiducial pattern detection. The method 100 and/or a method 100 element or elements may be performed by an apparatus (e.g., electronic device, computing device, scanner, server, etc.). For example, the method 100 may be performed by the apparatus 302 described in relation to FIG. 3.

The apparatus may detect 102 fiducial pattern subsets in image subsets of an image of an object. An image is optical data. Examples of an image include a digital photograph, a set of pixels, data representing optical values (e.g., color and/or brightness), etc. An image of an object is an image that indicates and/or depicts an object. For example, an image of an object may be an array of pixel values, where one, some, or all of the pixel values correspond to the object or an appearance of the object. In some examples, the apparatus may capture the image. For instance, the apparatus may utilize an integrated image sensor to capture the image. In some examples, the apparatus may receive the image from another device (e.g., remote image sensor, remote camera, linked camera, networked device, etc.). The object may include a fiducial pattern (e.g., a pattern of marks, dots, lines, crosses, symbols, etc.) and/or may include a marking of a fiducial pattern. In some examples, the fiducial pattern may appear in the image. For instance, an image with a resolution (e.g., 600 dots per inch (dpi), 300 dpi or another resolution) may depict fiducial marks on a surface of the object. In some examples, some of the fiducial marks appearing in the image may be spaced (by 6, 8, 10 pixels, etc., for example) according to the capture distance and/or perspective of the image.

An image subset is a part or portion of an image. For example, an image subset may be a region of an image and/or a portion of data of the image. In some examples, an image subset may be a rectangular subset (e.g., tile, window, etc.) of the image data. In some examples, image subsets of an image may have set (e.g., fixed) dimensions (e.g., height and width in pixels, inches, centimeters, etc.) or dimensions for the image subsets may be determined. For example, the apparatus may determine image subset dimensions as a proportion of an image dimension or dimensions (e.g., image width / 5 by image height / 5, etc.). In some examples, image subsets may overlap with each other. For instance, a second image subset may overlap a first image subset in an overlapping region. In some examples, the overlapping region may include a portion (e.g., 10%, 25%, 50%, etc.) of the first image subset. In some examples, image subsets may not overlap with each other. In some examples, image subsets of an image may cover an image. In some examples, image subsets may cover a portion of an image (e.g., a portion or portions of the image corresponding to an object or objects). For instance, an apparatus may detect a portion of an image in which an object is located. The image subsets may cover the portion of the image in which the object is located.

In some examples, an image subset may include a quantity of samples of fiducial marks (e.g., dots) to determine a transformation mapping of coordinates of detected fiducial marks to coordinates in a grid (e.g., coordinates where the fiducial dots would exist on a planar surface). In some examples, image subset size may be determined as a fixed portion of the image relative to the size of the image (e.g., each image subset size may be determined as having a width and/or height that are a fixed portion of the image width and/or height (e.g., 5%, 10%, 12.5%, etc.)). In some examples, the image subset size may be determined in order to include a minimum number of marks or more per subset. In some examples, the image subset size may be restricted to allow processing of all subsets to be completed in a fixed amount of time.

A fiducial pattern subset is a part or portion of a fiducial pattern. For example, a fiducial pattern subset may include a subset of marks (e.g., dots, lines, crosses, characters, and/or symbols, etc.) of a fiducial pattern. In some examples, the fiducial pattern subsets may be subsets of a fiducial pattern grid that includes fiducial dots (e.g., fiducial dots on a non-planar or curved surface of the object). In some examples, the image subsets may exclude a portion or portions of the image that do not include the object.

In some examples, a fiducial pattern may be in a sparse arrangement on an object’s surface. For instance, fiducial marks (e.g., dots) may be arranged in a grid where the marks are spaced apart by a fixed amount (e.g., 2 millimeters (mm), 3.4 mm, etc.). In other examples, fiducial patterns may be provided in a denser arrangement.

In some examples, the apparatus may enhance the image of the object. For example, the apparatus may perform image filtering that enhances a difference (e.g., color difference and/or brightness difference) between marks of the fiducial pattern and other portions of the image. In some examples, the apparatus may enhance the image by applying a band pass filter to the image. For instance, the apparatus may apply a Difference of Gaussian (DoG) operator. In some examples, the DoG operator may amplify the presence of marks (e.g., dots) at a given scale. For an image with high-definition resolution (e.g., 1280 × 720 pixels), for instance, the image may be filtered with a high frequency Gaussian filter that may have a sigma (standard deviation) of 1.0 pixels and with a low frequency filter that may have a sigma of 6.0 pixels. In some examples, different DoG parameters may be utilized for different resolution sensors, viewing distances, and/or mark sizes. The difference of the filtered images may be a DoG-filtered image, which may be an example of an enhanced image. In some examples, the filters may be differenced to produce a single DoG filter that may be applied to the image, which approach may not utilize a separable property of the individual Gaussian filters that enables the two-dimensional (2D) NxN filter to be reduced to the application of a pair of one-dimensional (1D) 1xN filters in orthogonal directions.

In some examples, detecting 102 the fiducial pattern subsets may include detecting marks (e.g., mark positions in the image and/or image subsets). For example, the apparatus may search the image and/or image subsets for marks based on mark size, shape, color, brightness, and/or difference relative to other parts of the image (e.g., fiducial pattern background). In some examples, the apparatus may detect mark positions by determining local peaks and/or inverse peaks in an enhanced image (e.g., DoG-filtered image). For example, positions (e.g., pixels) in the image with a maximum or minimum value (e.g., brightness value) within a local neighborhood (e.g., 10 × 10 pixel neighborhood) may be detected as mark positions. In some examples, positions (e.g., positions of pixels) that meet a criterion (e.g., pixel(s) with a threshold brightness) may be detected as mark positions. For instance, positions associated with marks may be determined as locations of arrangements of pixels that satisfy the criterion. In some examples, non-maximum suppression may be used to ignore weaker marks. For instance, some marks that satisfy a given criterion to a lesser extent than other marks may be ignored. Other approaches may be utilized in other examples (e.g., mark shape correlation, color detection, etc.). Detecting marks may result in a representation of the positions of marks relative to the image. The positions may be utilized to determine the fiducial pattern subsets.

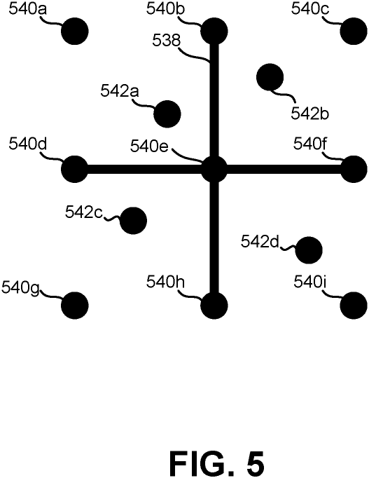

In some examples, detecting 102 fiducial pattern subsets may include detecting pattern structures. A pattern structure is a relationship between marks. For instance, a pattern structure may be a sub-structure of a fiducial pattern and/or grid. Examples of a pattern structure may include lines between marks, line crossings, shapes formed with marks, etc. For instance, the apparatus may detect line crossings (e.g., orthogonal line crossings) based on mark positions. For example, a line crossing may include five marks, where a line of three of the marks intersects (e.g., approximately orthogonally intersects) another line of three of the marks at a central mark. In some examples, line crossings may be uniquely defined with respect to a mark (e.g., central mark). An example of a pattern structure is illustrated in FIG. 5. In some examples, other pattern structures (besides line crossings) may be used. For instance, other pattern structures corresponding to a grid may be utilized. For example, triangles, rectangles, squares, hexagons, etc., may be used. A fiducial pattern and/or fiducial pattern subset may include a pattern structure or pattern structures.

In some examples, a distribution of nearest mark distances (that may be larger than a minimum detection distance, for instance) may be determined and used to define a local region within which potential pattern structures (e.g., line crossings), around each mark are selected. For instance, the apparatus may determine a distance to a nearest neighbor mark for each mark (e.g., each detected mark position). For example, the apparatus may determine a geometric distance (e.g., Euclidean distance in the image in terms of pixels, inches, centimeters, and/or another unit) from each mark to a nearest neighbor mark. The set of distances corresponding to each mark may form a distribution. In some examples, local region size may be determined based on the distribution. For instance, a radius of the local region may be defined as three times the 80th percentile of the distribution (where distances that are less than a limiting dot pitch may be ignored, for example). Other approaches to define a radius of the local region are possible, including approaches based on the distribution noted above or approaches without recourse to such a distribution (e.g., static radius). Within the local region (e.g., radius), potential pattern structures around each mark may be selected.

In some examples, the apparatus may find a pattern structure (e.g., most likely pattern structure) within the local region around each mark. For instance, the position of each local region may be defined relative to each respective mark (e.g., centered at each respective mark). In some examples, pattern structure detection may proceed by finding first dimension candidates (e.g., vertical and/or “north-south” candidates) and second dimension candidates (e.g., horizontal and/or “east-west” candidates) that are approximately orthogonal (within a range, such as 5 degrees, for instance). In some examples, first dimension candidates may be within 45 degrees (or less) of a vertical direction in the image with respect to the mark under consideration. In some examples, to be a valid pair, three marks (e.g., dots) of a first dimension pair including the central mark (around which the local region may be defined) may be approximately colinear. First dimension mark pairs may be approximately equally spaced on either side of the central mark, depending on a percentage length difference (longer to shorter). In some examples, a percentage length difference range may be set at 10% or another value. In some examples, the percentage length difference range may relate to a slope difference in the plane of the surface from which the image is captured of approximately 25 degrees (e.g., arccos of 0.9 assuming orthogonal projection). Second dimension pairs may be found with a similar approach in some examples.

In some examples, first dimension and second dimension pairs may have similar lengths to satisfy the percentage length difference range. For instance, the apparatus may detect pattern structures that satisfy an angular criterion (e.g., lines within an angular range of orthogonality) and/or a percentage length difference criterion (e.g., lines within the length difference criterion range). Other criteria may be utilized in other examples. In ambiguous cases where multiple line crossings satisfy the criteria within the local region of a mark, a line crossing with a smaller size may be selected in some examples. In some examples, multiple candidate line crossings at each mark may be determined. A candidate line crossing may be selected (and/or other candidates discarded) that allows a closer connection with other line crossing candidates and/or that more closely aligns with a fiducial pattern subset. In some examples, pattern structures may be connected if a line of a pattern structure overlaps with a line of another pattern structure (e.g., neighboring pattern structure). In some examples, pattern structures may be connected if a line of a pattern structure forms an angle with a line of another pattern structure (e.g., neighboring pattern structure) that is within an angular threshold (e.g., 1 degree, 2 degrees, 3.5 degrees, 5 degrees, etc.). In some examples, another criterion or criteria may be utilized to determine whether pattern structures are connected. A fiducial pattern subset may include a pattern structure or connected pattern structures.

The apparatus may select 104 a first image subset that includes a largest fiducial pattern subset. In some examples, the apparatus may compare fiducial pattern subsets and/or a fiducial pattern subset aspect or aspects (e.g., number of marks, range, and/or area) to select a first image subset. For example, the apparatus may select a first image subset that includes a fiducial pattern subset that includes a greatest number of marks, that covers a largest area, and/or that extends over a greatest range. For instance, a largest fiducial pattern subset may be larger than the other fiducial pattern subsets in terms of number of marks, area, and/or range. In a case where multiple fiducial pattern subsets have a largest size, one of the fiducial pattern subsets may be selected (at random or in accordance with a criterion, such as a spatial criterion, for instance).

In some examples, the apparatus may fit a grid to the largest fiducial pattern subset (e.g., set of line crossings) in the first image subset. For instance, the apparatus may fit a grid with a homography (e.g., rotation, translation, scaling, and/or perspective projection) to the largest fiducial pattern subset. A homography is a mapping. For instance, a homography may be a mapping between two 2D patterns according to an assumption that the patterns are on a planar surface under perspective projection. For example, the apparatus may rotate, translate, scale, and/or perspectively project a grid to approximately match the grid to the fiducial pattern subset. In some examples, the apparatus may extend the grid over the first image subset. For instance, the apparatus may extend the grid to the edges of the first image subset. The apparatus may identify marks and/or connect marks to the fiducial pattern subset (and/or grid) that are nearest to grid intersections (e.g., corners).

The apparatus may extend 106 the first fiducial pattern subset from the first image subset to a neighboring second image subset. In some examples, a neighboring image subset may be adjacent to another image subset. In some examples, a neighboring image subset may be adjacent to and/or nearest to another image subset along an image dimension (e.g., along a vertical or horizontal dimension of the image). In some examples, a neighboring image subset may overlap with another image subset. For instance, no other image subset may overlap more than a neighboring image subset. In some examples, extending 106 the first fiducial pattern subset from the first image subset to a neighboring second image subset may include extending (e.g., lengthening) a line or lines of the first fiducial pattern subset (and/or extending a grid of the first fiducial pattern subset) into the second image subset (e.g., in an overlapping region and/or beyond the first image subset), identifying a mark or marks in the second subset that align with a pattern structure or structures (e.g., grid) of the first fiducial pattern subset, and/or connecting a mark or marks (e.g., pattern structure(s)) in the second image subset to the first fiducial pattern subset. For example, the apparatus may identify, select, and/or connect mark(s) in the second image subset that are within a threshold distance from a line (e.g., within a threshold distance to a nearest point of the line) or lines extended from the first fiducial pattern subset.

In some examples, extending 106 the first fiducial pattern subset may include extending a grid by using a homography applied to the grid extended from the first image subset and detecting marks in the neighboring second image subset based on the extended grid. In some examples, the homography may be a homography corresponding to the first image subset or may be a new homography computed based on marks (e.g., grid points) located in an overlapping region. In some examples, extending 106 the first fiducial pattern subset may be guided by a homography (e.g., a homography of an overlapping region). For instance, the first fiducial pattern subset may be extended in accordance with (e.g., in alignment with) the homography.

In some examples, the apparatus may extend the first fiducial pattern subset outward from the first image subset to additional neighboring image subsets. For instance, the apparatus may extend the first fiducial pattern subset outward from the first image subset to four neighboring image subsets. In some examples, the apparatus may extend the first fiducial pattern subset to a third image subset from the second image subset.

In some examples, an element or elements of the method 100 may be omitted or combined. In some examples, the method 100 may include one, some, or all of the operations, elements, etc., described in relation to any of FIGS. 1-8.

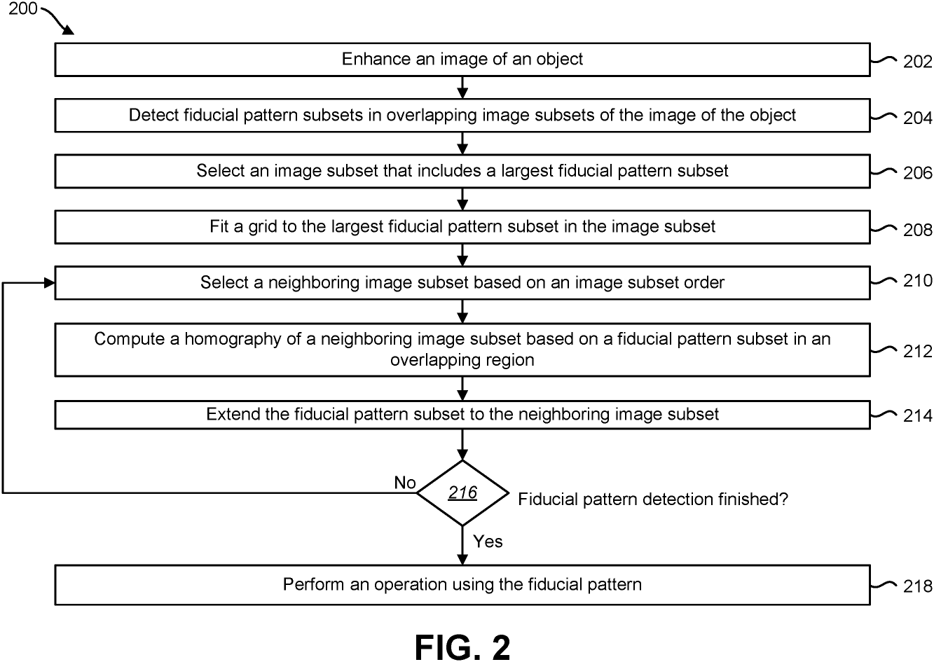

FIG. 2 is a flow diagram illustrating an example of a method 200 for fiducial pattern detection. The method 200 may be an example of the method 100 described in relation to FIG. 1. The method 200 and/or a method 200 element or elements may be performed by an apparatus (e.g., electronic device, computing device, server, smartphone, laptop computer, tablet device, scanning device, etc.). For example, the method 200 may be performed by the apparatus 302 described in relation to FIG. 3.

The apparatus may enhance 202 an image of an object. In some examples, enhancing 202 the image of the object may be performed as described in relation to FIG. 1.

The apparatus may detect 204 fiducial pattern subsets in overlapping image subsets of the image of the object. In some examples, detecting 204 the fiducial pattern subsets may be performed as described in relation to FIG. 1 for overlapping image subsets. For example, the apparatus may detect marks and/or pattern structures in the image subsets. A fiducial pattern subset may include a pattern structure or connected pattern structures.

The apparatus may select 206 an image subset that includes a largest fiducial pattern subset. In some examples, selecting 206 the image subset may be accomplished as described in relation to FIG. 1. For example, the apparatus may compare fiducial pattern subsets and/or a fiducial pattern subset aspect or aspects (e.g., number of marks, range, and/or area) of the image subsets and select an image subset with a largest fiducial pattern subset.

The apparatus may fit 208 a grid to the largest fiducial pattern subset in the image subset (e.g., in the selected image subset). In some examples, fitting 208 the grid to the largest fiducial pattern subset may be accomplished as described in relation to FIG. 1. For instance, the apparatus may fit the grid to the largest fiducial pattern subset with a homography.

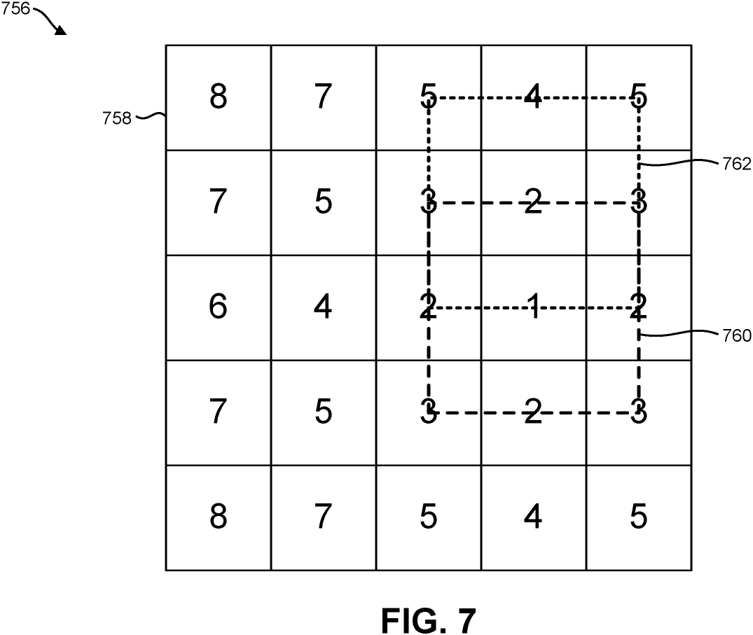

The apparatus may select 210 a neighboring image subset (e.g., next neighboring image subset) based on an image subset order. An image subset order is an order that indicates a spatial sequence for fiducial pattern detection and/or fiducial pattern subset extension. For example, an image subset order may specify an order in which a neighboring image subset (for which fiducial pattern detection has not been completed) to an earliest image subset (for which fiducial pattern detection has been completed) may be selected next. In some examples, the image subset order may specify a sequence of image subsets that progresses outwardly from the initial image subset (e.g., the image subset that initially has the largest fiducial pattern subset). In some examples, the image subset order may indicate neighboring image subsets to the initial subset, followed by neighbors of the neighboring image subsets, and so on, where neighbors to earlier image subsets (e.g., lowest-numbered image subsets) are prioritized. An example of an image subset order is illustrated in FIG. 7.

The apparatus may compute 212 a homography of a neighboring image subset based on a fiducial pattern subset in an overlapping region. For example, the apparatus may compute a homography of the neighboring image subset that approximately aligns a grid with the fiducial pattern subset (and/or pattern structures) of the overlapping region. In some examples, the homography may be further refined to use the fiducial pattern of the entire neighboring image subset. For example, the overlapping region may be used to compute a homography (e.g., putative homography), which may be used to extend 214 the fiducial pattern subset as described below (e.g., extend the grid from the image subset to include fiducials in the neighboring image subset). In some examples, the homography may be refined by iteratively extending and fitting to obtain a set of fiducial marks that extend the grid (e.g., that best extend the grid) into the neighboring image subset based on a newly computed homography.

The apparatus may extend 214 the fiducial pattern subset to the neighboring image subset. In some examples, the apparatus may extend the grid over the image subset, which may include the overlapping region with the neighboring image subset. In some examples, the apparatus may extend the grid beyond the overlapping region in the neighboring image subset. For example, the apparatus may extend the fiducial pattern subset to the remainder of the neighboring image subset guided by the homography. In some examples, the apparatus may identify marks and/or connect marks (e.g., previously unconnected marks) to the fiducial pattern subset. For instance, marks that are nearest to intersections of the grid may be identified as fiducial marks.

The apparatus may determine 216 whether fiducial pattern detection is finished. For example, the apparatus may determine whether fiducial pattern detection has been performed for each of the image subsets. In a case that fiducial pattern detection is not finished, the apparatus may return to select 210 a neighboring image subset (e.g., next neighboring image subset) based on an image subset order. For the selected neighboring subset (e.g., next image subset), the apparatus may compute 212 a homography for a neighboring image subset and extend 214 the fiducial pattern to the neighboring image subset. In some examples, these procedures or operations may be iterated until fiducial pattern detection is finished.

In some examples, performing fiducial pattern detection for the image subsets may result in the fiducial marks from each of the image subsets being approximately aligned to a global grid. For instance, each of the image subsets may have a respective homography (e.g., transformation) that approximately aligns the fiducial marks of the image subsets to a global grid.

In a case that fiducial pattern detection is finished, the apparatus may perform 218 an operation using the fiducial pattern. Some examples of an operation may include decoding data marks (e.g., dots) relative to the fiducial pattern grid, determining an attribute or attributes of the object based on the fiducial pattern grid, and/or printing a representation of the object based on the fiducial pattern grid.

In some examples, the apparatus may decode data marks relative to the fiducial pattern grid. Data marks are marks that indicate information. Examples of data marks may include dots, lines, crosses, characters, and/or symbols. In some examples, data marks may be encoded according to a spatial relationship relative to fiducial marks. For example, marks on an object may include data marks and fiducial marks. In some examples, a grid (e.g., virtual grid) may be formed from the detected fiducial dots as described herein. The fiducial dots may be aligned along approximately orthogonal axes that form virtual square unit cells in a fiducial pattern. In some examples, a data dot or data dots may appear within each cell. For instance, a data dot may be placed at any one of nine vertices of a 3×3 virtual array within each cell. The location of the data dot within each cell of the alignment grid may encode one of nine data symbols. In some examples, other data mark positions relative to the fiducial pattern may be defined and/or more than one data mark may be provided within a cell. In some examples, the apparatus may decode a data mark by determining a data mark position relative to the fiducial pattern and selecting a corresponding data symbol. For instance, the apparatus may decode data dots relative to the fiducial pattern grid.

In some examples, the apparatus may determine an attribute of the object based on the fiducial pattern grid. Examples of an attribute of an object may include object shape, object pose (e.g., position and/or orientation), surface depth, etc. For instance, the apparatus may determine object shape based on the homographies corresponding to the image subsets as indicated in relation to the fiducial pattern grid. For example, each homography may indicate object shape (e.g., approximate surface plane orientation) in each image subset. In some examples, the apparatus may utilize the fiducial pattern grid to determine object pose. For instance, the apparatus may determine the position and/or orientation of the object in three-dimensional (3D) space relative to the fiducial pattern grid as indicated by the homographies of the image subsets. In some examples, the apparatus may utilize the fiducial pattern grid to determine surface depth of an object. For example, the homographies of the fiducial pattern grid corresponding to the image subsets may indicate a depth of each fiducial mark (according to a geometric relationship with the homography).

In some examples, performing 218 the operation(s) may include displaying data, sending data, and/or printing based on the fiducial pattern. For example, the apparatus may display data on a display (and/or send data to a display) that indicates decoded data, object shape, object pose, and/or surface depth. For instance, decoded data may indicate a name, a type, a date, ownership, a brand, a price, other information, etc. For example, the decoded data may indicate the name and price of an object indicated by data dots. In some examples, the apparatus may render a representation (e.g., a 3D model) of the object and display the representation on a display and/or send the representation to another device (e.g., remote device, networked device, etc.). For instance, the apparatus may utilize the pose, surface, and/or depth data to render the representation (e.g., an image of a 3D model in a 3D space). In some examples, the apparatus may utilize the pose, surface, and/or depth data to print a 2D and/or 3D representation of the object. In some examples, an element or elements of the method 200 may be omitted or combined.

FIG. 3 is a block diagram of an example of an apparatus 302 that may be used in fiducial pattern detection. The apparatus 302 may be an electronic device, such as a personal computer, a server computer, a smartphone, a tablet computer, scanning device, etc. The apparatus 302 may include and/or may be coupled to a processor 304 and/or a memory 306. The apparatus 302 may include additional components (not shown) and/or some of the components described herein may be removed and/or modified without departing from the scope of this disclosure.

The processor 304 may be any of a central processing unit (CPU), a digital signal processor (DSP), a semiconductor-based microprocessor, graphics processing unit (GPU), field-programmable gate array (FPGA), an application-specific integrated circuit (ASIC), and/or other hardware device suitable for retrieval and execution of instructions stored in the memory 306. The processor 304 may fetch, decode, and/or execute instructions stored in the memory 306. In some examples, the processor 304 may include an electronic circuit or circuits that include electronic components for performing a function or functions of the instructions. In some examples, the processor 304 may be implemented to perform one, some, or all of the functions, operations, elements, methods, etc., described in relation to one, some, or all of FIGS. 1-8.

The memory 306 is an electronic, magnetic, optical, and/or other physical storage device that contains or stores electronic information (e.g., instructions and/or data). The memory 306 may be, for example, Random Access Memory (RAM), Electrically Erasable Programmable Read-Only Memory (EEPROM), a storage device, an optical disc, and/or the like. In some examples, the memory 306 may be volatile and/or non-volatile memory, such as Dynamic Random Access Memory (DRAM), EEPROM, magnetoresistive random-access memory (MRAM), phase change RAM (PCRAM), memristor, flash memory, and/or the like. In some implementations, the memory 306 may be a non-transitory tangible machine-readable storage medium, where the term “non-transitory” does not encompass transitory propagating signals. In some examples, the memory 306 may include multiple devices (e.g., a RAM card and a solid-state drive (SSD)).

In some examples, the apparatus 302 may include a communication interface 324 through which the processor 304 may communicate with an external device or devices (e.g., networked device, server, smartphone, printer, etc.). In some examples, the apparatus 302 may be in communication with (e.g., coupled to, have a communication link with) an image sensor. In some examples, the apparatus 302 may include an integrated image sensor.

The communication interface 324 may include hardware and/or machine-readable instructions to enable the processor 304 to communicate with the external device or devices. The communication interface 324 may enable a wired and/or wireless connection to the external device or devices. In some examples, the communication interface 324 may include a network interface card and/or may also include hardware and/or machine-readable instructions to enable the processor 304 to communicate with various input and/or output devices. Examples of output devices include a printer, a 3D printer, a display, etc. Examples of input devices include a keyboard, a mouse, a touch screen, etc., through which a user may input instructions and/or data into the apparatus 302.

In some examples, the memory 306 of the apparatus 302 may store image data 308, dot data 310, dot detection instructions 312, fiducial dot subset determination instructions 314, image subset determination instructions 316, and/or extension instructions 318. The image data 308 is data that indicates an image or images. For example, the image data 308 may indicate or depict an object or objects with marks (e.g., dots). The dot data 310 is data that indicates dots of an object or objects. For example, the dot data 310 may indicate positions of detected dots in the image data 308.

The dot detection instructions 312 are instructions to detect dots in an image or images of an object or objects. In some examples, the dot detection instructions 312 may include executable code to detect the positions of dots in an image. In some examples, the processor 304 may execute the dot detection instructions 312 to detect dots in an image of an object as described in relation to FIG. 1 and/or FIG. 2. For instance, the processor 304 may enhance and/or filter an image or images. In some examples, the processor 304 may detect the dots by determining peaks and/or locations in the image(s) that meet a criterion or criteria. The detected dots (e.g., dot positions) may be stored as dot data 310 in memory 306.

The fiducial dot subset determination instructions 314 are instructions to determine fiducial dot subsets of the dots in image subsets of the image. For example, a fiducial dot subset may be an example of the fiducial pattern subsets described herein. In some examples, the processor 304 may execute the fiducial dot subset determination instructions 314 to determine fiducial dot subsets in image subsets as described in relation to FIG. 1 and/or FIG. 2. For instance, the processor 304 may detect line crossings from groups of five dots, where a fiducial dot subset may include dots corresponding to a detected line crossing or connected line crossings.

The image subset determination instructions 316 are instructions to select an image subset from the image subsets based on a fiducial dot subset property. For example, a fiducial dot subset property may be an example of the fiducial pattern subset aspects (e.g., number of dots, spatial range, and/or area size) described herein. In some examples, the processor 304 may execute the image subset determination instructions 316 to select an image subset from the image subsets as described in relation to FIG. 1 and/or FIG. 2. For instance, the processor 304 may compare fiducial dot subset properties corresponding to an image subset and/or may select an image subset with a fiducial dot subset with greatest number of dots, largest spatial range, and/or largest area size.

The extension instructions 318 are instructions to connect fiducial dots based on an image subset order from the selected image subset. In some examples, the processor 304 may execute the extension instructions 318 to connect fiducial dots based on an image subset order as described in relation to FIG. 1 and/or FIG. 2. For instance, the processor 304 may connect dots from the selected image subset to a neighboring image subset or subsets based on an image subset order. In some examples, the image subset order proceeds outwardly to neighboring image subsets. For example, lines and/or a grid corresponding to fiducial dots in an image subset may be extended to fiducial dots in a neighboring image subset. The extended lines and/or grid may be utilized to identify fiducial dots in the neighboring image subset and/or may be utilized to connect fiducial dots between image subsets.

In some examples, the processor 304 may compute a respective homography for each of the image subsets. For example, the memory 306 may include homography computation instructions. In some examples, the homography computation instructions may be separate from or included in the fiducial dot subset determination instructions 314 and/or the extension instructions 318. The processor 304 may execute the homography computation instructions to compute a homography for each of the image subsets. In some examples, the processor 304 may compute the homography for each of the image subsets as described in relation to FIG. 1 and/or FIG. 2. For example, the processor 304 may transform (e.g., rotate, translate, scale, project, etc.) each image subset and/or a grid corresponding to each image subset to compute the homography for each image subset. In some examples, each homography may align a grid with fiducial dots. In some examples, a homography or homographies may be utilized to guide extending a grid. In some examples, an element or elements of the apparatus 302 may be omitted or combined.

Some examples of the techniques described herein may be utilized to provide plane-based fiducial pattern detection on curved surfaces. Some examples of the techniques described herein may enable fiducial pattern detection without prior information regarding surface curvature and/or shape. Some examples of the techniques described herein may enable relatively fast fiducial pattern detection with relatively low computational complexity compared with other approaches. Some examples of the techniques described herein may allow 3D fiducial and/or data marking that is not restricted to planar surfaces and/or flat regions. For example, 3D fiducial marking and/or data marking may be placed on and/or recoverable from curved surfaces and/or non-planar surfaces. For example, fiducial marks and/or data marks may appear as a visual wrapping on a curved object.

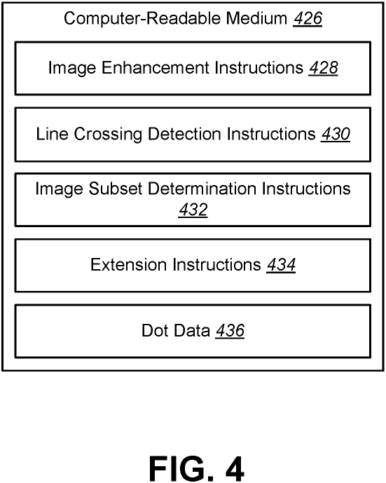

FIG. 4 is a block diagram illustrating an example of a computer-readable medium 426 for fiducial pattern detection. The computer-readable medium 426 is a non-transitory, tangible computer-readable medium. The computer-readable medium 426 may be, for example, RAM, EEPROM, a storage device, an optical disc, and the like. In some examples, the computer-readable medium 426 may be volatile and/or non-volatile memory, such as DRAM, EEPROM, MRAM, PCRAM, memristor, flash memory, and the like. In some implementations, the memory 306 described in relation to FIG. 3 may be an example of the computer-readable medium 426 described in relation to FIG. 4.

The computer-readable medium 426 may include code (e.g., data and/or instructions). For example, the computer-readable medium 426 may include image enhancement instructions 428, line crossing detection instructions 430, image subset determination instructions 432, extension instructions 434, and/or dot data 436. The dot data 436 is data indicating positions of dots in an image or images.

The image enhancement instructions 428 may include code to cause a processor to enhance an image of an object with fiducial dots. In some examples, the image may be enhanced as described in relation to FIG. 1, FIG. 2, and/or FIG. 3. For instance, a processor may enhance an image by performing DoG filtering on the image. The enhanced image may be utilized to detect dots (e.g., fiducial dots and/or data dots). Dot positions may be stored as dot data 436.

The line crossing detection instructions 430 may include code to cause a processor to detect line crossings of the fiducial dots in image subsets of the image. In some examples, the line crossings may be detected as described in relation to FIG. 1, FIG. 2, and/or FIG. 3. For instance, a processor may detect line crossings that satisfy an angular criterion and/or a percentage length difference criterion.

The image subset determination instructions 432 may include code to cause a processor to determine a first image subset corresponding to a largest connected set of the detected line crossings. In some examples, the first image subset may be determined as described in relation to FIG. 1, FIG. 2, and/or FIG. 3. For example, the processor may determine a first image subset that includes a fiducial pattern subset that includes a greatest number of marks, that covers a largest area, and/or that extends over a greatest range.

The extension instructions 434 may include code to cause a processor to extend the largest connected set into second neighboring image subsets. In some examples, extending the largest connected set into second neighboring image subsets may be performed as described in relation to FIG. 1, FIG. 2, and/or FIG. 3. For example, the extension instructions 434 may include code to cause a processor to fit a grid to the largest connected set in the first image subset. In some examples, the extension instructions 434 may include code to cause a processor to expand the grid in the first image subset and/or code to cause a processor to identify a portion of fiducial dots that are nearest to grid intersections (e.g., corners of the grid). The grid may be fitted in and/or expanded to overlapping regions between the first image subset and second neighboring image subsets. Respective homographies for the second neighboring subsets may be computed based on identified fiducial dots in respective overlapping regions. Expanded grids for the respective neighboring second image subsets may be determined, thereby further extending the largest connected set into the second neighboring image subsets.

FIG. 5 is a diagram illustrating an example of a line crossing 538 in accordance with some examples of the techniques described herein. Examples of fiducial dots 540a-i are illustrated. Examples of data dots 542a-d are also illustrated. The line crossing 538 may be detected in accordance with some examples of the techniques described herein.

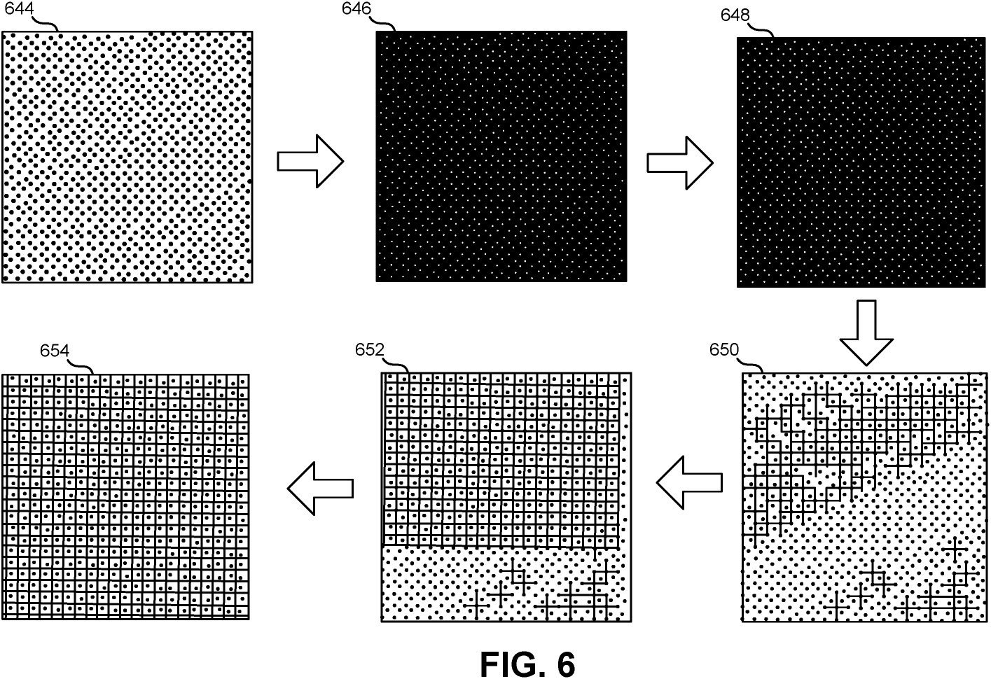

FIG. 6 is a diagram illustrating an example of an image subset 644 in accordance with some examples of the techniques described herein. The image subset 644 may include dots. In some examples, the dots may be dot halftones of a flat gray image. In some examples, a portion (e.g., approximately half) of the dots may be included in a fiducial pattern, and another portion (e.g., approximately half) may be data dots that may represent embedded data. In some examples, marks indicating information or data dots may be referred to as carriers. In some examples, the fiducial dots may serve as anchors for recovery of the data dots and/or may blend into the halftone pattern. The fiducial dots may be useful for non-planar surfaces due to the unpredictable orientation distortions imparted by general surfaces. In some examples, the fiducial dots may be aligned for data recovery.

To handle general surfaces, which may include non-planar (e.g., curved) surfaces, an image may be divided into image subsets. In some examples, image subsets may correspond to curved areas of an object that can be approximated as planar. In some examples, fiducial pattern detection (e.g., grid detection) may be performed for each of the image subsets as described herein. FIG. 6 provides an example of fiducial pattern detection for an image subset 644. For example, the image subset 644 may be a portion of a captured image (e.g., captured digital image). For example, an image may be divided into image subsets of a smaller size that may allow a curved surface to approximated as planar.

In some examples, the image subset 644 may be enhanced to reduce noise and/or to amplify the locations of the dots using a DoG filter and/or DoG operator. An example of an enhanced image subset 646 is illustrated in FIG. 6. In some examples, dot detection may be performed. An example of detected dot positions 648 is illustrated in FIG. 6.

In some examples, line crossings may be detected to isolate the fiducial dots from the data dots. For example, a line crossing may include 5 fiducial dots at intersections of lines formed by approximately orthogonal lines. An example of the image subset with detected line crossings 650 is illustrated in FIG. 6.

In some examples, an image subset with a largest connected set of line crossings may be determined. For example, the image subset with detected line crossings 650 may be selected.

In some examples, the selected image subset may be used to fit a grid (e.g., prospectively corrected grid) with a homography. An example of the image subset with a fitted grid 652 is illustrated in FIG. 6.

In some examples, the grid may be expanded to cover an image subset. An example of the image subset with an expanded grid 654 is illustrated in FIG. 6. The expanded grid may be utilized to identify fiducial dots. For example, fiducial dots may be identified as dots that are nearest to grid corners and/or intersections.

FIG. 7 is a diagram illustrating an example of an image subset order 756 in accordance with some examples of the techniques described herein. For clarity in illustration, numbered boxes 758 indicating the image subset order 756 are illustrated in FIG. 7. Each of the numbered boxes 758 may correspond to an image subset, where the image subsets overlap. For instance, a first image subset 760 is illustrated centered over numbered box 1. A neighboring second image subset 762 is illustrated centered over a numbered box 2. In this example, each image subset is twice the size of a numbered box. The image subset order 756 may cover a whole image or a portion of an image that includes a fiducial pattern.

The image may be divided into image subsets corresponding to the numbered boxes 758. In some examples, the image subsets may overlap with neighboring image subsets by 50% horizontally and vertically. Other amounts of overlap may be utilized in some examples.

In some examples, fiducial pattern detection may be performed over the whole image or a portion of the image. For example, fiducial pattern detection may be performed over all of the image subsets as described herein. The image subset with the largest fiducial pattern subset (e.g., connected set of line crossings) may be selected. In the example of FIG. 7, the first image subset 760 corresponding to numbered box 1 is selected as the first image subset. A grid may be determined for the first image subset and/or aligned as described in some examples of the techniques described herein (e.g., as described in relation to FIG. 6).

The nearest neighboring image subsets corresponding to numbered boxes 2 may be processed next (e.g., in parallel and/or in a sequence, such as a clockwise sequence, counter-clockwise sequence, random sequence, a sequence based on nearness to a largest fiducial pattern subset, or other sequence). For example, the fiducial pattern subset and/or grid may be extended into the second image subset 762. In some examples, the identified fiducial marks in the overlapping region between the first image subset 760 and the second image subset 762 may be utilized to determine a grid with a new homography, which may be utilized to identify the fiducial marks in the remaining portion of the second image subset 762. Similar operations may be performed for each of the image subsets corresponding to numbered boxes 2. Progressing outwardly, the next nearest image subsets may correspond to the numbered boxes 3. These image subsets may have an overlap from neighboring image subsets corresponding to numbered box 1 and some numbered boxes 2. The fiducial marks in the overlapping regions (which cover 75% of the image subset with a numbered box 3) may be utilized to determine a grid and to detect the remaining fiducial marks. Fiducial detection may continue in accordance with the image subset order 756 for image subsets corresponding to numbered boxes 4-8. The image subset order 756 may allow for extension across planar approximations of a non-planar surface, using alignment as propagated from a starting image subset with a highest confidence.

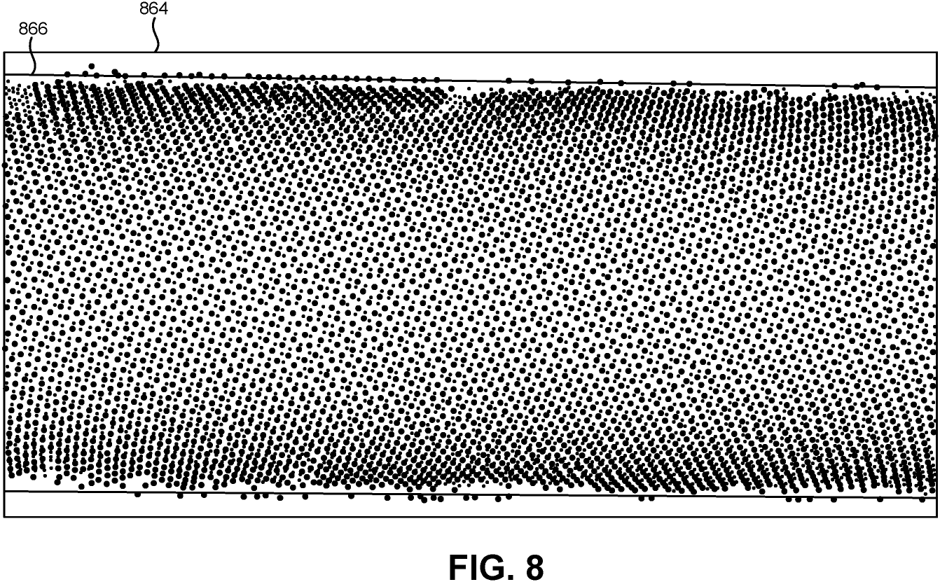

FIG. 8 is a diagram illustrating an example of an image 864 of a cylindrical object 866 with a detected fiducial pattern in accordance with some examples of the techniques described herein. For instance, the image 864 may be captured with a mobile device. The cylindrical object 866 is a 1.5-inch radius cylinder with a camera distance of 6 inches. In the example of FIG. 8, the fiducial pattern has a rotation angle of 30 degrees (e.g., the axes of the fiducial pattern are rotated by 30 degrees with respect to an end of the cylinder). The cylinder axis is approximately horizontal, and edges of the cylinder are in the field of view. In this example, heavier dots correspond to fiducial dots detected in accordance with some examples of the techniques described herein, and lighter dots correspond to data dots. Some false positive detections may occur in some cases.

While various examples are described herein, the described techniques are not limited to the examples. Variations of the examples described herein may be implemented within the scope of the disclosure. For example, operations, functions, aspects, or elements of the examples described herein may be omitted or combined.

1. A method, comprising:
detecting fiducial pattern subsets in image subsets of an image of an object;
selecting a first image subset that includes a largest first fiducial pattern subset; and
extending the first fiducial pattern subset from the first image subset to a neighboring second image subset.

2. The method of claim 1, wherein the object is a non-planar object.

3. The method of claim 2, wherein the second image subset overlaps the first image subset in an overlapping region.

4. The method of claim 3, further comprising computing a homography of the second image subset based on a fiducial pattern subset in the overlapping region, wherein extending the first fiducial pattern subset is guided by the homography.

5. The method of claim 1, further comprising extending the first fiducial pattern subset outward from the first image subset to additional neighboring image subsets.

6. The method of claim 5, further comprising extending the first fiducial pattern subset to a third image subset from the second image subset.

7. The method of claim 1, wherein the fiducial pattern subsets are subsets of a fiducial pattern grid that includes fiducial dots.

8. The method of claim 7, further comprising decoding data dots relative to the fiducial pattern grid.

9. The method of claim 7, further comprising determining an attribute of the object based on the fiducial pattern grid.

10. An apparatus, comprising:
a memory; and
a processor coupled to the memory, wherein the processor is to:
detect dots in an image of an object;
determine fiducial dot subsets of the dots in image subsets of the image;
select an image subset from the image subsets based on a fiducial dot subset property; and
connect fiducial dots based on an image subset order from the selected image subset.

11. The apparatus of claim 10, wherein the image subset order proceeds outwardly to neighboring image subsets.

12. The apparatus of claim 11, wherein the processor is to compute a respective homography for each of the image subsets to guide extending a grid.

13. A non-transitory tangible computer-readable medium storing executable code, comprising:
code to cause a processor to enhance an image of an object with fiducial dots;
code to cause the processor to detect line crossings of the fiducial dots in image subsets of the image;
code to cause the processor to determine a first image subset corresponding to a largest connected set of the detected line crossings; and
code to cause the processor to extend the largest connected set into second neighboring image subsets.

14. The computer-readable medium of claim 13, further comprising code to cause the processor to fit a grid to the largest connected set in the first image subset.

15. The computer-readable medium of claim 14, further comprising:
code to cause the processor to expand the grid in the first image subset; and
code to cause the processor to identify a portion of the fiducial dots that are nearest to grid intersections.
